(19) United States
(12) Patent Application Publication
(10) Pub. No.: US 2016/0098743 A1
(43) Pub. Date: Apr. 7, 2016

(54) POINT OF SALE SYSTEM AND METHOD

(71) Applicant: Wm Morrison Supermarkets PLC, Bradford (GB)

(72) Inventors: Nick Collard, Harrogate (GB); Crawford Davidson, Rugby (GB); Alex Beardsall, Leeds (GB); Helen Godley, Harrogate (GB); Colin Hulmes, Knebworth (GB); Clive Head, Milton Keynes (GB)

(21) Appl. No.: 14/580,479

(22) Filed: Dec. 23, 2014

(30) Foreign Application Priority Data
Oct. 2, 2014 (GB) 1417434.6

(51) Int. Cl. G06Q 30/02

(52) U.S. Cl. CPC G06Q 30/0226; G06Q 30/0238

(57) ABSTRACT

A point of sale system comprises at least one point of sale terminal arranged to receive an identifier for identifying customer account information associated with a customer and for identifying a first set of products and determining a first price for the first set of products. The point of sale system is further arranged to identify a second set of products based on the first set of products and determine a second price for the second set of products, determine a quantity of reward points in dependence upon the determined first and second prices, and to modify the identified customer account information based on the determined quantity of reward points.

The present invention relates to Point of Sale systems and methods for their operation.

Point of Sale (PoS) systems manage the execution of retail transactions, often determining the payment due for products or services to be purchased, recording the receipt of funds, recording the completion of the transaction and issuance of receipts. The PoS system therefore requires access to information regarding the products or services offered by a retailer including the price. PoS systems may also incorporate warehousing functions to update relevant stock indicators upon completion of transactions.

More recently, PoS systems have also been used to implement customer loyalty reward schemes. Such schemes generally provide a quantity of reward “points” to a customer based upon the value of that customer's transactions with a retail location operating the reward scheme. The customer may then be able to redeem acquired reward points for products or services with the retail location or third party providers. PoS systems may therefore incorporate what are known as Customer Relationship Management (CRM) features, allowing the PoS to identify particular customers and to access and update reward points balances of that customer.

It is an object of the invention to provide improved PoS systems and methods for their operation.

According to a first aspect, there is provided a point of sale system, comprising: at least one point of sale terminal arranged to receive a customer identifier and identify a first set of products. The point of sale system is further arranged to identify customer account information associated with the customer identifier, determine a first price associated with the first set of products, identify a second set of products based on the first set of products and determine a second price associated with the second set, determine a quantity of reward points in dependence upon the determined first and second prices, and modify the identified customer account information based on the determined quantity of reward points.

In this way, the point of sale system of the first aspect provides an efficient system for updating customer account information based upon differences in prices between products purchased during a transaction and other, matching, products, such as products available from external entities. It will be understood that reward points may be a non-cash value that can be associated with a customer account and may be exchanged for credit, products or services, etc. In a further example, the reward points may represent a fixed percentage discount redeemable against a further transaction.

Identifying the second set may comprise receiving information relating to a third set of products associated with a first entity and comparing products in the first set with products in the third set to identify associated products. The second set products may comprise at least one product from the third set having at least one associated product in the first set. In this way, the update to the customer account information is effected only based on products of the first set which have matching products in the third set.

Identification of associated products may comprise identification of products in the first set and the third set that have at least one matching or similar attribute, or which have a predetermined minimum number of matching or similar attributes.

Determining the first price may comprise determining a price of a first subset of the first set of products, each product in the first subset having at least one associated product in the third set.

The point of sale system may be arranged to receive information relating to a plurality of third sets of products, each of said plurality of third sets being associated with a respective one of a plurality of entities, and identify a plurality of first subsets of the first set and identify a plurality of second sets of products based on the plurality of third sets. In this way, the update to the customer account information may be effected based on differences in price between products identified by the point of sale terminal and products associated with each of a plurality of external entities.

The point of sale system may be further arranged to determine a price for each of the plurality of first subsets, determine a price for each the plurality of second sets, and to determine a quantity of reward points in dependence upon the determined prices.

Each of the plurality of first subsets may be associated with a respective one of the plurality of second sets. Determining a quantity of reward points may comprises comparing the price of each of the first sets with the price of its associated second set.

The point of sale system may further comprise a printer and may further be arranged to receive an indication that a quantity of reward points associated with the identified customer account has exceeded a predetermined threshold and to print a voucher in dependence upon the quantity of reward points associated with the identified customer account. The voucher may indicate a credit value against which the voucher is redeemable.

According to a second aspect, there is provided a method of operating a point of sale system, comprising: receiving a customer identifier and identifying customer account information associated with the customer identifier; identifying a first set of products and determining a first price associated with the first set of products; identifying a second set of external products based on the first set of products and determine a second price associated with the second set; determining a quantity of reward points in dependence upon the determined first and second prices; and modifying the identified customer account information based on the determined quantity of reward points.

It will be appreciated that aspects of the present invention can be implemented in any convenient way including by way of suitable hardware and/or software. For example, devices arranged to implement embodiment& may be created using appropriate hardware components. Alternatively, a programmable device may be programmed to implement embodiments.

The invention therefore also provides suitable computer programs for implementing aspects described herein. Such computer programs can be carried on suitable carrier media including tangible carrier media (e.g. hard disks, CD ROMs and so on) and intangible carrier media such as communications signals.

It will further be appreciated that features described above in connection with one aspect may be used in combination with other aspects. For example, features described above in connection with the system of the first aspect, may be implemented in the method of the second aspect.

Ordering of features within the aspects described above, or in the appended claims, is not indicative of a temporal relationship between those features. It is to be further understood that unless otherwise specified, terms such as first, second, third, etc. are merely labels and do not indicate any temporal relationships.

An embodiment of the invention is now described, by way of example only, with reference to the accompanying drawings, in which:

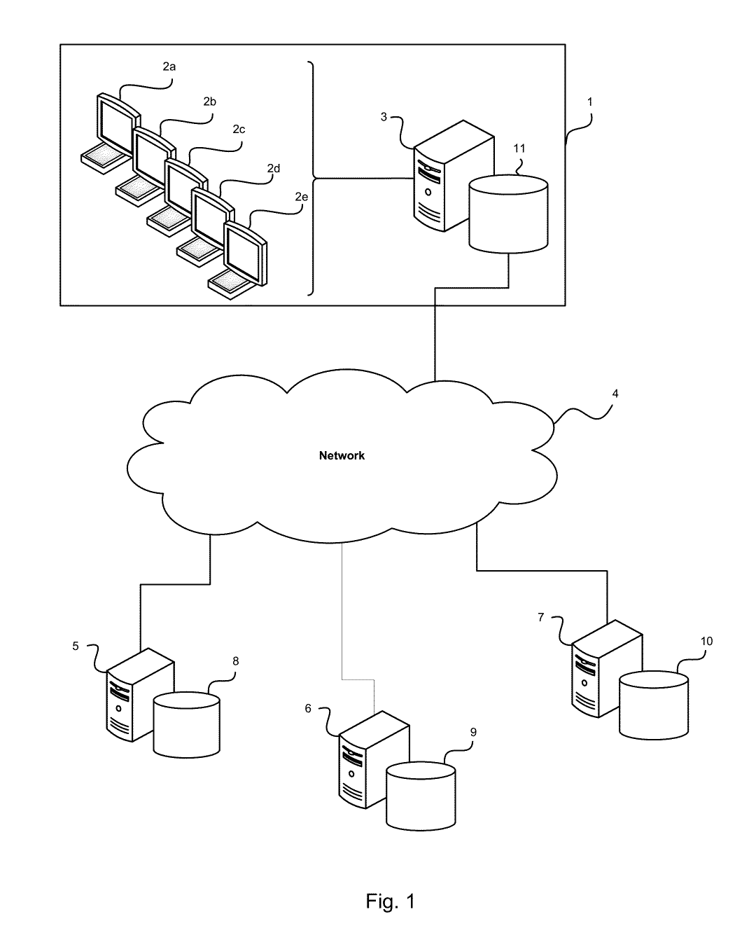

FIG. 1 is a schematic representation of a point of sale network suitable for implementing embodiments described herein;

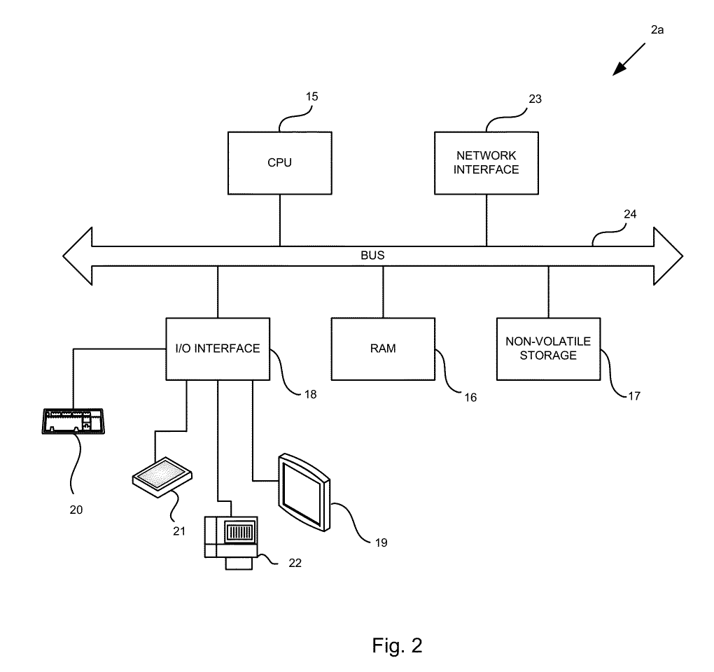

FIG. 2 is a schematic representation of components which may be used to implement components of FIG. 1;

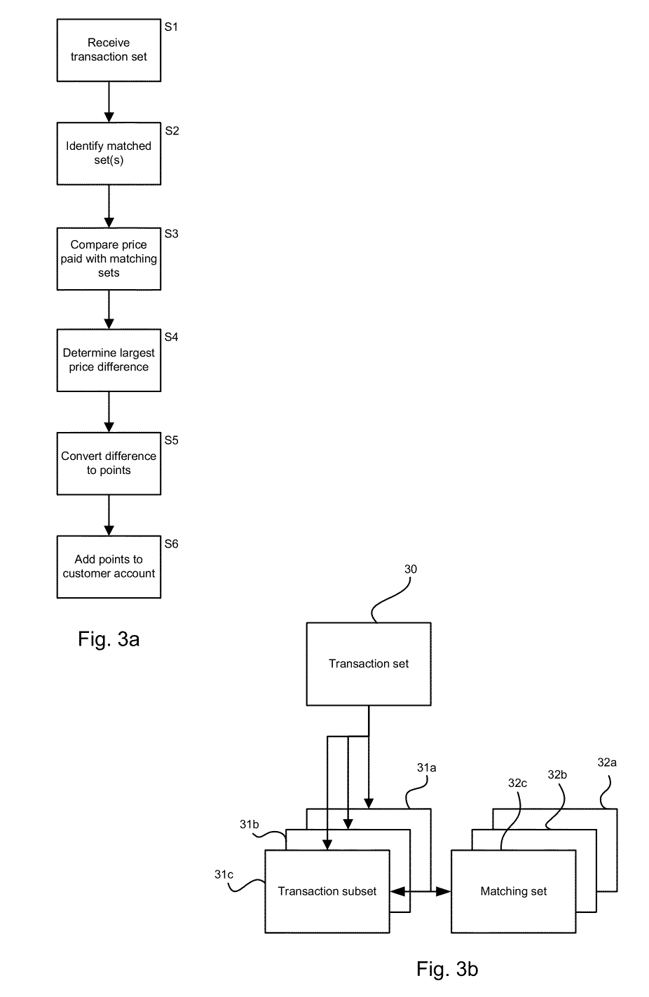

FIG. 3a is a flowchart showing processing carried out to credit customer reward points by the components of FIG. 1;

FIG. 3b is a schematic representation of data items that may be used during the processing of FIG. 3a;

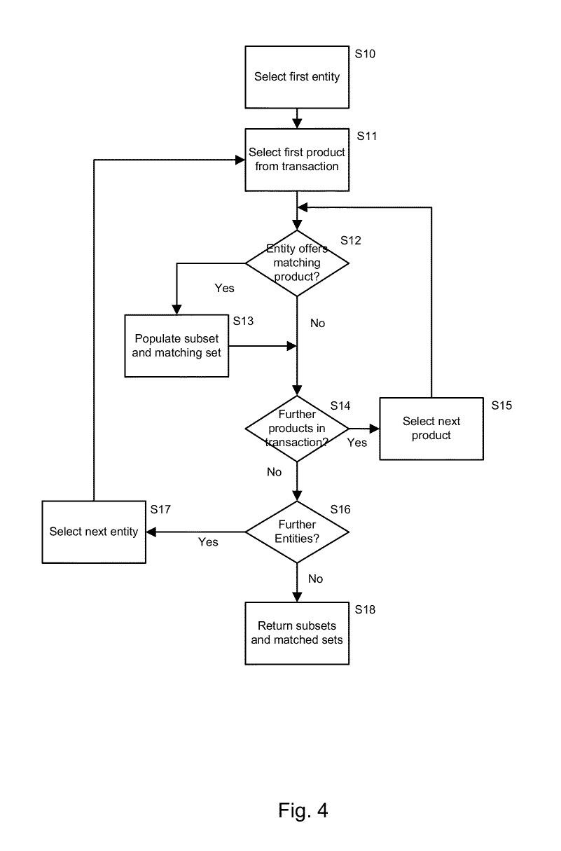

FIG. 4 is a flowchart showing processing that may be carried out to create the data items schematically illustrated in FIG. 3a; and

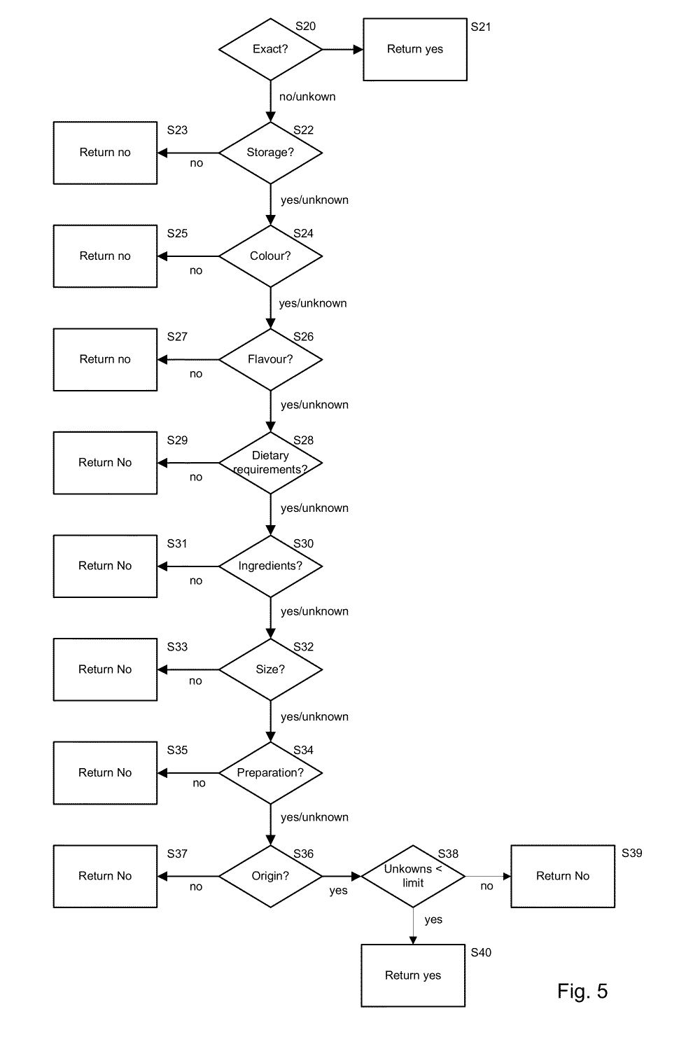

FIG. 5 is a flowchart showing processing that may be carried out to determine whether two products are considered to match.

In FIG. 1 there is illustrated a network of devices that may be used to implement embodiments of the present invention. A retail location 1 has a plurality of PoS terminals 2a-2e. Each PoS terminal 2a-2e is connected to a local server 3. The local server 3 is connected to a network 4. Remote servers 5, 6, 7 also connect to the network 4 such that data may be exchanged between the retail location server 3 and the servers 5, 6, 7.

The network 4 may be any suitable public or private network and may be, for example, the Internet. The connections between the PoS terminals 2a-2e, the local server 3, the remote servers 5, 6, 7 and the network 4 may each take any appropriate form and may be wired or wireless connections.

The server 5 has an associated database 8 and is arranged to manage information regarding products, services, etc. (referred to as “products” herein below for clarity) that may be offered for sale at the retail location 1. The server 5 may be, for example, a central server for a retail group of which the retail location 1 is part. The server 5 is arranged to provide relevant product information to the local server 3. Data that may be provided by the server 5 may comprise, for example, stock keeping units (SKUs) for the products offered by the retail location 1 together with associated product descriptions and prices.

The server 6 has an associated database 9 and is arranged to manage information regarding products offered by external entities (which may be for example, competitor retailers). The server 6 may be arranged to receive information regarding products offered by external entities from a third party (e.g. another computer connected to the network 4) or may be arranged to obtain such information itself. For example, the server 6 may be arranged to “scrape” pricing and product information from websites, associated with external entities, accessible over the network 4, using known techniques. In either case, the server 6 is arranged to receive information regarding products offered by third parties and to provide all or part of that information to the store server 3 or to the server 5.

The server 7 has an associated database 10 and is arranged to manage information regarding customers of the retail location 1. In particular, the server 7 is arranged to store and manage, for each customer, a record of a balance of reward points assigned to that customer. The server 7 may perform other customer relationship management (CRM) processing, such as associating reward scheme redemption vouchers with customer accounts, recording and managing customer preferences, etc.

As indicated above, the servers 5, 6, 7 are remote servers which may be managed by a centralised function of a retail group to which the retail location 1 belongs. The remote servers 5, 6, 7 are configured to provide relevant data over the network 4 to the local server 3. For example, the retail location server 3 may be provided with information relating to the products offered by the retail location 1 by the server 5, information regarding products offered by external entities by the server 6, and with information indicating to a customer's reward point balance by the server 7. Data received and processed at the retail location server 3 may be stored in a database 11.

The local server 3 is arranged to provide information to the PoS terminals 2a-2e. For example, the PoS terminals 2a-2e may be “thin” clients arranged to perform a relatively limited set of processing operations locally with remaining processing being performed by the server 3. Alternatively, the server 3 may perform only that processing which utilises data from a plurality of the PoS terminals 2a-2e, such as stock-keeping.

While only a single retail location 1 is depicted in FIG. 1, it is to be understood that PoS networks as described herein may comprise a plurality of retail locations. For example, the retail location 1 may be part of a chain of retail locations connected to the network 4 and the servers 5, 6, 7. More generally, it is be understood that the arrangement of FIG. 1 is merely exemplary and that a suitable PoS network may be arranged in any appropriate fashion. For example, while the retail location 1 is shown as comprising a local server 3 it will be appreciated that a retail location may comprise a plurality of local servers, each responsible for, or responsible in part for, processing described in more detail below.

Alternatively, the retail location 1 may not comprise a dedicated local server 3, with the PoS terminals 2a-2e having respective individual connections to the network 4 and the servers 5, 6, 7, and being arranged to perform individually, or in a distributed manner, processing relevant to the retail location 1. In this way, data may be provided to the PoS terminals 2a-2e in substantially real-time. Similarly, each of the servers 5, 6 and 7 may be implemented as a respective plurality of servers. In alternative embodiments, functionality ascribed herein to the respective servers 3, 5, 6 and 7 may be provided by any combination of more or fewer servers, local to or remote from the retail location 1, and/or by the PoS terminals 2a-2e.

Further, while in the example of FIG. 1 the PoS terminals 2a-2e are located at a retail location 1, it will be appreciated that the PoS terminals 2a-2e may be any devices suitable for providing a point of sale for a transaction. For example, the PoS terminals 2a-2e may be network connected devices (such as home computers, mobile telephones, tablets, etc.) that can be used to conduct transactions over, for example, the Internet, using a network application (such as a suitable website) provided by a retailer.

It will further be appreciated that, for the sake of clarity, standard network and data processing components have been omitted from the network of FIG. 1. For example, networking components such as routers, firewalls and data interfaces are not depicted, their implementation within the network of FIG. 1 being apparent to the skilled person in light of the teaching herein.

In general, and as described in more detail below with reference to the processing shown in FIGS. 3 to 5, the PoS system shown in FIG. 1 is configured to perform price comparisons of products purchased during transactions at the retail location 1 with matching products offered by external entities, to determine a price difference between those products and to determine a quantity of reward points to be provided to the customer in dependence upon the price difference.

FIG. 2 is a schematic representation of components that may be used to implement the PoS terminal 2a in an exemplary embodiment of the invention. In the example of FIG. 2, the PoS terminal 2a a CPU 15 which is configured to read and execute instructions stored in a random access memory (RAM) 16. The RAM 16 stores instructions for execution by the CPU 15 and data used by those instructions. For example, instructions used to process products purchased at the PoS terminal 2a, and to compare those products with products offered by external entities, may be loaded into the RAM 16.

The PoS terminal 2a further comprises storage 17. The storage 17 may comprise the database 11. Further, computer readable instructions for causing the PoS terminal 2a to process products and perform price comparison operations may be stored in the storage 17. The PoS terminal 2a further comprises an I/O interface 18 to which are connected peripheral devices used in connection with the PoS terminal 2a. More particularly, a display 19 is configured so as to display output from the PoS terminal 2a. Input devices are also connected to the I/O interface 18. Such input devices include a keyboard 20, a barcode scanner 21, and a printer 22 which together allow products details (such as barcodes) to be entered at the PoS terminal 2a and for receipts and vouchers to be printed.

A network interface 23 allows the PoS terminal 2a to be connected to other computer devices, such as the retail location server 3 so as to receive and transmit data. The CPU 15, RAM 17, volatile storage 18, I/O interface 18, and network interface 23, are connected together by a bus 24.

The PoS terminals 2b-2e and the servers 3, 5, 6, 7, may each implemented similarly to the arrangement shown in FIG. 2. It will be appreciated, however, that the arrangement of components illustrated in FIG. 2 is merely exemplary, and that the PoS terminal 2a may comprise additional or fewer components than those illustrated. Indeed, the PoS terminals 2a-2e and the servers 3, 5, 6, 7 may be implemented using any appropriate configuration as will be readily appreciated by those skilled in the art.

With reference to FIGS. 3a, 3b, there is now described exemplary processing that may be carried out to determine a quantity of reward points to be added to a customer account of a customer completing a transaction at the retail location 1. It is to be taken that, at a point before or during the processing of FIG. 3, the customer engaged in the transaction is identified to the PoS terminal 2a. Such identification of the customer may be by any method that allows details of that customer's reward scheme account to be obtained. With reference to the example PoS system of FIG. 1, the processing of FIG. 3 may, for example, be performed by the PoS terminals 2a-2e, or by the local server 3.

At step S1, a transaction set 30 (see FIG. 3b) is received at the PoS terminal 2a. The transaction set 30 is the set of all products purchased during the transaction. For example, the transaction set 30 may be received through the scanning of barcodes at the scanner 21, and/or product inputting of identifiers using the keyboard 20. In some embodiments, the further processing of FIG. 3a may be conditional upon the received transaction set 30 meeting certain predetermined requirements. For example, in an embodiment the further processing of FIG. 3a may be conditional on a received transaction set 30 having a minimum number of products, or having a minimum price. In other embodiments, and as shown in FIG. 3a, the further processing of FIG. 3a is not conditional upon attributes of the received transaction set 30.

At step S2, one or more transaction subsets 31a-31c are identified by determining, for the products within the transaction set 30, corresponding products offered by external entities based on data received from the server 6. In particular, each transaction subset 31a-31c corresponds to a particular external entity (e.g. a particular competitor) and includes those products of the transaction set for which a corresponding product is offered by that external entity. Each transaction subset 31a-31c therefore has an associated matching set 32a-32c containing the corresponding products that are available from the particular external entity. It will be appreciated that where an external entity offers matching products for every product within the transaction set 30, the transaction subset 31a-31c associated with that external entity will comprise all of the products in the transaction set 30 and the corresponding matching set 32a-32c will include a matching product for every product within the transaction set 30. On the other hand, where an external entity does not offer products matching those products in the transaction set 30, no transaction subset or matching set is established for that external entity. Each transaction subset 31a-31c may therefore each comprise a different subset of the products within the transaction set 30. Identifying matching sets may be performed in any of a plurality of ways. One example of processing that may be performed to identify matching sets is described below with reference to FIG. 4.

Each of the matching sets 32a-32c has an associated price based upon the information that is received at and provided by the server 6. Referring again to FIG. 3a, processing passes from step S2 to step S3 at which the price of each transaction subset 31a-31c is compared with the price of the corresponding matching set 32a-32c. That is, the price that was paid for the products in each subset is compared with the price that would have been paid for the matching products at the external entity.

Processing then passes to step S4, at which the price difference between the transaction subset 31a-31c that is most expensive compared to its associated matching 32a-32c set is identified. That is, at step S4 it is determined which of the matching sets 32a-32c would provide the largest cost saving if the customer had purchased the products in that matching set 32a-32c from the associated external entity, rather than purchasing the products in the transaction subset 31a-31c from the retail location 1, and the value of that cost saving.

Processing passes to step S5 at which the price difference determined at step S4 is converted into a quantity of reward points. The particular way in which the quantity of reward points is calculated from the price difference will depend upon the particular reward scheme operated by the retail location 1, the currency of the transaction, etc.

At step S6, the quantity of reward points calculated at step S5 is added to the reward account of the customer of the transaction. As described above, customer details that allow identification of the correct reward account may be received at any time before or during the processing of FIG. 3a and may be received using any appropriate mechanism. For example, customer details may be provided to the PoS terminal 2a by scanning a “loyalty card” on which the customer details are recorded, at the scanner 21. In an alternative example, the customer details may be provided from a mobile device associated with the customer through, e.g., near-field communication, Bluetooth or infrared receivers, etc. In a further example, where the PoS terminal 2a comprises a device configured to access a retail website (e.g. a mobile telephone), the customer details may be received through a log-in process performed using the PoS terminal 2a.

By the processing described above, reward points can be allocated to customers in dependence upon a determined difference in price between an actual transaction at the retail location 1, and a similar transaction executed at an external entity. In a particular embodiment, the quantity of the reward points may be exchanged at the retail location 1 (or associated retail locations) for a value equivalent to that of the price difference calculated at step S4. In this way, the PoS system provides a particularly efficient method of reimbursing a customer for a determined price difference incurred as a result of completing the transaction at the store 1 rather than a compared external entity.

FIG. 4 is a flowchart illustrating an example of processing that may be carried out to populate the transaction subsets 31a-31c and the matching sets 32a-32c. With reference to the example PoS system of FIG. 1, the processing of FIG. 4 (or other processing to compare prices of products of a transaction with prices of matching products offered by external entities) may, for example, be performed by the PoS terminals 2a-2e, or by the local server 3.

At step S10, a first external entity is selected from the external entities for whom data is provided by the server 6. The selected entity is the “current entity” for the processing of FIG. 4. As described above, transaction subset-matching set pair is associated with a particular one of the external entities for whom data is provided by the server 6. Where information is maintained for a plurality of external entities, selection of entities at step S10 (and at step S17) may comprise selection from a subset of those external entities.

Processing passes to step S11, at which a first product in the transaction set 30 is selected as the “current product”. Processing passes from step S11 to step S12, at which it is determined whether the current entity offers a product that matches the current product.

The determination as to whether an entity offers a matching product may be performed in any appropriate manner and will be determined in practice by the particular reward scheme. An example of processing that may be performed to determine whether two products match is described below with reference to FIG. 5. In some embodiments, processing to determine whether two products match may be performed “offline” with respect to the processing of FIG. 4. Step S12, therefore, may be performed as a look-up operation of pre-populated matching products database, which may be stored, for example, at the PoS terminal 2a-2e or at the database 11. In other examples, where products offered by external entities change rapidly, the processing of step S12 may, for example, comprise a request for matching products, sent to the server 6 over the network 4 and receipt of a response from the server 6 indicating which (if any) products offered by the current entity match the current product.

If it is determined at step S12 that the current entity has a product matching the current product, processing passes to step S13 at which the current product is added to a transaction subset 31a-31c and the matching product is added to an associated matching set 32a-32c. Because transaction subsets and associated matching sets are generated only in the event that an external entity offers at least one matching product, a transaction subset and associated matching set for the current entity may be established only upon identification of a first matching product.

Processing passes from step S12 to step S14. If, on the other hand, it is determined at step S12 that the current entity does not offer any products matching the current product, processing passes directly from step S12 to step S14. At step S14 it is determined whether there are any products in the transaction set 30 for which it has not been determined whether the current entity offers a matching product. If it is determined at step S14 that there are further products in the transaction set 30, processing passes to step S15 at which a next product in the transaction set 30 is selected as the current product. Processing passes from step S15 to step S12. Processing therefore loops between steps S12 to step S15 until all of the products in the transaction set 30 have been processed to determine whether the current entity offers matching products.

When it is determined, at step S14, that there are no further products in the transaction set 30, processing passes from step S14 to step S16. At step S16 it is determined whether there are further external entities with which to perform comparisons. If it is determined at step S16 that there are further external entities, processing passes from step S16 to step S17 and a next external entity is selected as the current entity. Processing passes from step S17 to step S11 and the first product in the transaction set 30 is set as the current product.

Processing therefore loops between step S11 and step S17 until each of the products in the transaction set 30 have been processed for each of the external entities with whom prices are to be compared. When it is determined at step S16 that there are no further external entities to process, processing passes to step S18 at which the populated transaction subsets 31a-31c and corresponding matching sets 32a-32c are returned.

FIG. 5 is a flowchart showing processing that may be used to determine whether a particular product, in particular an edible or potable product, offered by an external entity matches a particular product offered by the retail location 1. It will be appreciated that different processing may be used, for example, for other types of product. In general terms, the processing of FIG. 5 compares information about products offered by the retail location 1 (e.g. as provided by the server 5) with information about products offered by external entities (e.g. as provided by the server 6). The processing of FIG. 5 may be performed, for example, by the server 3. It will be appreciated that determinations as to which products offered by external entities match those offered by the retail location 1 may be performed separately and prior to the processing of FIG. 4. Information stored about each product offered by the retail location 1 may therefore also comprise information regarding matching products. In this way, the processing at step S12 of FIG. 4 may only require a look-up of the pre-stored matches for each particular product within the transaction set 30.

Referring to FIG. 5, at step S20 it is determined whether the products (i.e. the product offered by the retail location 1 and the product offered by the external entity) are an exact match. Products may be determined to be an exact match if, for example, barcodes printed on the products are identical. If it is determined that the products are identical, processing passes to step S21 at which processing returns with an indication that the products match. An association may therefore be stored indicating that the product offered by the external entity matches the product offered by the retail location 1 for use in the processing of FIG. 4 described above.

If, on the other hand, it is determined at step S20 that the products are not an exact match, processing passes to step S22 at which it is determined whether the products are stored in the same way. For example, a determination may be made as to whether the products both require refrigeration. If it is determined that the products have different recorded storage requirements, processing passes from step S22 to step S23 at which processing returns with an indication that the products do not match. No association will be created between the products in this case. If on the other hand, it is determined that the products have the same recorded storage requirements, or if it is unknown (e.g. storage requirements are not recorded for either product), processing passes to step S24. Where processing passes to step S24 because it is unknown as to whether the storage requirements are the same, a counter monitoring the number of unknowns is incremented by one.

At step S24 it is determined whether the products have the same recorded colour information. If it is determined that the products each have different recorded colour information, processing returns at step S25 with an indication that the products do not match. If, on the other hand, it is determined at step S24 that the products have the same recorded colour information, or if suitable colour information is not available for either product, processing passes to step S26. If processing passes to step S26 because colour information is not available, the unknown value counter is incremented by one.

At step S26 it is determined whether recorded flavour information is the same for each product. If it is determined that the flavour information recorded for each product is different, processing returns at step S27 with an indication that the products do not match. If, on the other hand, it is determined at step S26 that the products have the same recorded flavour information, or if suitable flavour information is not available for either product, processing passes to step S28. If processing passes to step S28 because flavour information is not available, the unknown value counter is incremented by one.

At step S28 it is determined whether recorded dietary requirements information is the same for each product. If it is determined that the dietary requirements information (e.g. vegetarian, gluten-free, etc.) for each product is different, processing returns at step S29 with an indication that the products do not match. If, on the other hand, it is determined at step S28 that the products have the same recorded dietary requirement information, or if suitable dietary requirement information is not available for either product, processing passes to step S30. If processing passes to step S30 because suitable dietary requirement information is not available, the unknown value counter is incremented by one.

At step S30 it is determined whether recorded ingredients information is sufficiently similar for each product. For example, it may be determined whether the products share the same ‘top five ingredients by weight’. It will be appreciated, however, that the determination as to whether ingredients are sufficiently similar may be performed in any appropriate way and may be dependent upon the particular type of product being compared. If it is determined that the ingredients of each product are not sufficiently similar, processing returns at step S31 with an indication that the products do not match. If, on the other hand, it is determined at step S30 that ingredients of the products are sufficiently similar, or if suitable ingredient information is not available for either product, processing passes to step S32. If processing passes to step S32 because suitable ingredient information is not available, the unknown value counter is incremented by one.

At step S32 it is determined whether recorded size information is the same for each product (e.g. packaging dimensions, or relative indicators such as “small”, “medium”, “large” etc.) If it is determined that the size information for each product is different, processing returns at step S33 with an indication that the products do not match. If, on the other hand, it is determined at step S32 that the products have the same recorded size information, or if suitable size information is not available for either product, processing passes to step S34. If processing passes to step S34 because suitable size information is not available, the unknown value counter is incremented by one.

At step S34 it is determined whether recorded preparation instructions (e.g. microwave, bake, steam, etc.) is the same for each product. If it is determined that the preparation instructions recorded for each product are different, processing returns at step S35 with an indication that the products do not match. If, on the other hand, it is determined at step S34 that the products have the same recorded preparation instructions, or if suitable preparation instructions are not available for either product, processing passes to step S35. If processing passes to step S35 because suitable preparation instructions are not available, the unknown value counter is incremented by one.

At step S36 it is determined whether recorded geographical origin indications are the same for each product. If it is determined that the geographical origin indications recorded for each product are different, processing returns at step S37 with an indication that the products do not match. If, on the other hand, it is determined at step S36 that the products have the same recorded geographical origin indications, or if suitable geographical origin instructions are not available for either product, processing passes to step S38. If processing passes to step S38 because suitable geographical origin indications are not available, the unknown value counter is incremented by one.

At step S38 it is determined whether the unknown value counter has a value that exceeds a predetermined threshold. If it is determined that the unknown value counter has exceeded the predetermined threshold, this may be taken to indicate that a determination as to whether the products match cannot be made with a required degree of accuracy, and processing returns at step S39 with an indication that the products do not match. If, on the other hand, it is determined at step S38 that the unknown value counter has not exceeded the predetermined threshold, this may be taken to indicate that sufficient attributes of the products match, and processing returns at step S40 with an indication that the products do match.

As indicated above, the processing described with reference to FIG. 5 is merely exemplary and may be implemented in any of a number of ways in dependence upon requirements of the reward scheme. For example, where the retailer operating the retail location 1 offers similar items across a number of product ranges (e.g. branded, own-brand, etc.), in some embodiments comparisons may be made only within product ranges of external entities that are deemed to be equivalent to those offered by the retail location 1.

It will be appreciated that reward scheme in operation at the retail location 1 may take any suitable form. In an embodiment, reward points added to a customer account may be exchangeable at the retail location 1 and associated retail locations directly, e.g. for discounts, products, services, etc. Additionally or alternatively, reward points may be exchanged by the customer, or may be exchanged automatically, upon reaching a predetermined threshold, for vouchers having a cash value. For example, following the processing of FIG. 3a, a determination may be made (for example through communication with the server 7) as to whether, as a result of reward points added during the transaction, the balance of the reward points associated with the customer exceeds a predetermined threshold. If it is determined that the balance of reward points does exceed the threshold, a voucher may be printed automatically at the PoS terminal 2a-2e. The voucher may have a cash or percentage value associated therewith to be redeemed in a future transaction. In a further example, a value (e.g. cash or percentage) may be deducted automatically from a price paid for the transaction set 30 in dependence upon a quantity of reward point assigned to the user account.

It will further be appreciated that while example embodiments are described above, modifications may be made to those examples without departing from the scope of the appended claims.

1. A point of sale system, comprising:
at least one point of sale terminal arranged to:
receive a customer identifier;
identify a first set of products;
the point of sale system further being arranged to:
identify customer account information associated with the customer identifier;
determine a first price associated with the first set of products;
identify a second set of products based on the first set of products and determine a second price associated with the second set;
determine a quantity of reward points in dependence upon the determined first and second prices; and
modify the identified customer account information based on the determined quantity of reward points.

2. The point of sale system of claim 1, wherein identifying the second set comprises:
receiving information relating to a third set of products associated with a first entity; and
comparing products in the first set with products in the third set to identify associated products;
wherein the second set comprises at least one product from the third set having at least one associated product in the first set.

3. The point of sale system of claim 2, wherein determining the first price comprises determining a price of a first subset of the first set, each product in the first subset having at least one associated product in the third set.

4. The point of sale system of claim 3, further arranged to:
receive information relating to a plurality of third sets of products, each of said plurality of third sets being associated with a respective one of a plurality of entities; and
processing the plurality of third sets to identify a plurality of first subsets of the first set and to identify a matching plurality of second sets of products.

5. The point of sale system of claim 4, further arranged to:
determine a price for each of the plurality of first subsets and determine a price for each of the plurality of second sets; and
determine the quantity of reward points in dependence upon the determined prices.

6. The method of claim 5, wherein each of the plurality of first subsets is associated with a respective one of the plurality of second sets.

7. The method of claim 6, wherein determining a quantity of reward points comprises comparing the price of each of the first sets with the price of its associated second set.

8. The point of sale system of claim 7, wherein determining a quantity of reward points in dependence upon the determined prices comprises:
determining a largest price difference between one of the plurality of first subsets and a matching one of the plurality of second sets; and
determining the quantity of reward points in dependence upon the determined largest price difference.

9. The point of sale system claim 1, further comprising a printer and further being arranged to:
receive an indication that a quantity of reward points associated with the identified customer account has exceeded a predetermined threshold; and
print a voucher in dependence upon the quantity of reward points associated with the identified customer account.

10. A method of operating a point of sale system, comprising:
receiving a customer identifier and identifying customer account information associated with the customer identifier;
identifying a first set of products and determining a first price associated with the first set of products;
identifying a second set of external products based on the first set of products and determine a second price associated with the second set;
determining a quantity of reward points in dependence upon the determined first and second prices; and
modifying the identified customer account information based on the determined quantity of reward points.

11. A computer program comprising computer readable program code arranged to cause one or more computers to carry out a method according to claim 10.

12. A non-transitory computer readable medium carrying a computer program according to claim 11.

13. A computer apparatus comprising:
one or more processors; and
a memory storing computer readable program code arranged to cause the one or more processors to carry out a method according to claim 10.
